(19) United States
(12) Patent Application Publication
(10) Pub. No.: US 2019/0347067 A1
(43) Pub. Date: Nov. 14, 2019

(54) USER INTERFACE INTERACTION CHANNEL

(71) Applicant: SAP SE, Walldorf (DE)

(72) Inventor: Masoud Aghadavoodi Jolfaei, Wiesloch (DE)

(21) Appl. No.: 15/976,031

(22) Filed: May 10, 2018

(51) Int. Cl. G06F 3/16

(52) U.S. Cl. CPC G06F 3/167; H04L 67/26

(57) ABSTRACT

A method includes establishing a back-end communication channel with a user interface, receiving a voice or a remote command of a user to perform one or more user interface actions within the user interface, sending voice or remote information of the voice or remote command to a voice or a chatbot service provider, receiving, from the voice or the chatbot service provider, a data message generated based on the voice or remote information, identifying the one or more user interface actions based at least in part on the data message, sending, using the back-end communication channel, a push command message to the user interface, the push command message including the identified one or more user interface actions, and applying the identified one or more user interface actions within the user interface.

### BACKGROUND

Conversational user interfaces (UIs) are emerging interfaces for interactions between humans and computers. Conversational UIs can help streamline workflow by making it easier for users to get what they need at any moment (e.g., without finding a particular application, typing on a small screen, or having to click around). A conversational UI is a type of user interface that uses conversation as the main interaction between the user and the software. A user may engage with a conversational UI through speech or through a typed chat with a chatbot.

Transforming an existing application UI screen to a conversational UI would consume an inordinate amount of time and resources. For example, a development team would be required to acquire deep knowledge regarding the underlying text, voice or chatbot interaction service. Specifically, the development team must establish an end-to-end interaction model that depends on the underlying technology, the design and implementation of a proper interaction model (e.g., skills and intents), and integration into the application with respect to product standards (e.g., security, supportability, and lifecycle management).

Therefore, what is needed is a generic (e.g., voice- or text-based) way to access existing application UI screens. It is desired to provide an enhanced infrastructure for conversational UIs, where voice or text commands can be used to perform complex actions.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a block diagram of an overall system architecture according to some embodiments.

FIG. 2 is a sequence diagram of a use case according to some embodiments.

FIG. 3 is a flow diagram illustrating an exemplary process according to some embodiments.

FIG. 4 is a sequence diagram of a use case according to some embodiments.

FIG. 5 is a flow diagram illustrating an exemplary process according to some embodiments.

FIG. 6 is an outward view of a user interface according to some embodiments.

FIG. 7 is an outward view of a user interface according to some embodiments.

FIG. 8 is a block diagram of an apparatus according to some embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Described are embodiments directed to a UI interaction channel, and more specifically, enabling voice- or text-based access to UI screens of applications.

In general, the architecture described herein supports UI5 (e.g., SAPUI5/HTML/FIORI) based applications, but can also support other UI technologies (e.g., platforms) including, but not limited to Web Dynpro, WebGUI, SAPGUI, and Business Server Pages (BSP)) (e.g., web-based and non-web-based).

The environments described herein are merely exemplary, and it is contemplated that the techniques described may be extended to other implementation contexts. For example, it is contemplated that the disclosed embodiments can be applied to technologies, systems, and applications in augmented reality (AR).

One or more embodiments that include one or more of the advantages discussed are described in detail below with reference to the figures.

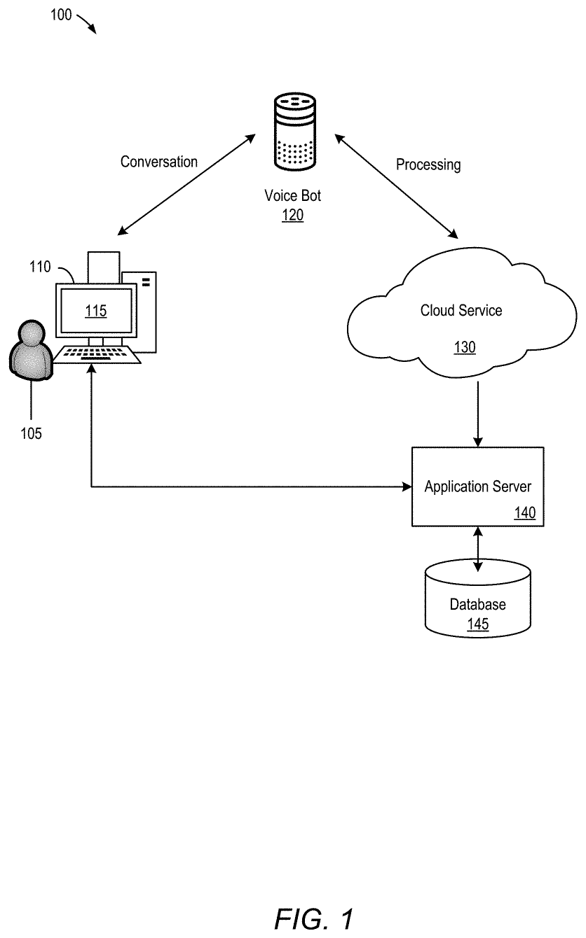

FIG. 1 is a schematic block diagram of an overall system architecture 100 according to some embodiments.

System 100 includes Enterprise Resource Planning (ERP) system 110, voice bot 120 (e.g., multi-functional intelligent/smart speaker), cloud-based service 130, application server 140, and database 145. Various components of system 100 may be operationally connected over a network, which may be wired or wireless. The network may be a public network such as the Internet, or a private network such as an intranet.

ERP system 110 may be hosted on a computing device, such as, but not limited to, a desktop computer, a computer server, a notebook computer, a tablet computer, and the like. ERP system 110 may include various components such as an ERP client device, an ERP server 140, and an ERP database 145. In an implementation, these components may be distributed over a client-server environment. In another implementation, however, they could be present within the same computing device.

Database 145 is provided by a database server which may be hosted by a server computer of application server 140 or on a separate physical computer in communication with the server computer of application server 140.

ERP system 110 includes a UI 115, and more specifically, a conversational UI, which may be presented to a user 105 on a display of an electronic device.

In an implementation ERP system includes an ERP system from SAP SE. However, in other implementations ERP systems by other vendors may be used.

Additionally or alternatively to enterprise applications and systems including ERP disclosed above, system 100 may support other kinds of business applications and systems (e.g. ABAP-based business applications and systems). Examples of such business applications and systems can include, but are not limited to, supply chain management (SCM), customer relationship management (CRM), supplier relationship management (SRM), product lifecycle management (PLM), extended warehouse management (EWM), extended transportation management (ETM), and the like.

The voice bot 120 includes one or more microphones or listening devices (not separately shown) that receive audio input and one or more speakers (not separately shown) to output audio signals, as well as processing and communications capabilities. User 105 may interact with the voice bot 120 via voice commands, and microphone(s) capture the user's speech. The voice bot 120 may communicate back to the user 105 by emitting audible response(s) through speaker(s).

Generally, voice bot 120 receives queries from user(s) 105. Cloud service 130 (e.g., cloud service provider platform), operatively coupled to voice bot 120, collects and stores information in the cloud. Most of the complex operations such as speech recognition, machine learning, and natural language understanding are handled in the cloud by cloud-based service 130. Cloud service 130 generates and provides messages (e.g., in HTTP(S) JSON format) to application server 140.

Application server 140 executes and provides services to applications (e.g., at 110). An application may comprise server-side executable program code (e.g., compiled code, scripts, etc.) which provide functionality to user(s) 105 by providing user interfaces to user(s) 105, receiving requests from user(s) 105, retrieving data from database 145 based on the requests, processing the data received from database 145, and providing the processed data to user(s) 105. An application (e.g., at 110) may be made available for execution by application server 140 via registration and/or other procedures which are known in the art.

Application server 140 provides any suitable interfaces through which user(s) 105 may communicate with an application executing on application server 140. For example, application server 140 may include a HyperText Transfer Protocol (HTTP) interface supporting a transient request/response protocol over Transmission Control Protocol (TCP), a WebSocket interface supporting non-transient full-duplex communications between application server 140 and any user(s) 105 which implement the WebSocket protocol over a single TCP connection, and/or an Open Data Protocol (OData) interface.

Presentation of a user interface 115 may comprise any degree or type of rendering, depending on the type of user interface code generated by application server 140. For example, a user 105 may execute a Web browser to request and receive a Web page (e.g., in HTML format) from application server 140 via HTTP, HTTPS, and/or WebSocket, and may render and present the Web page according to known protocols. One or more of user 105 may also or alternatively present user interfaces by executing a standalone executable file (e.g., an .exe file) or code (e.g., a JAVA applet) within a virtual machine.

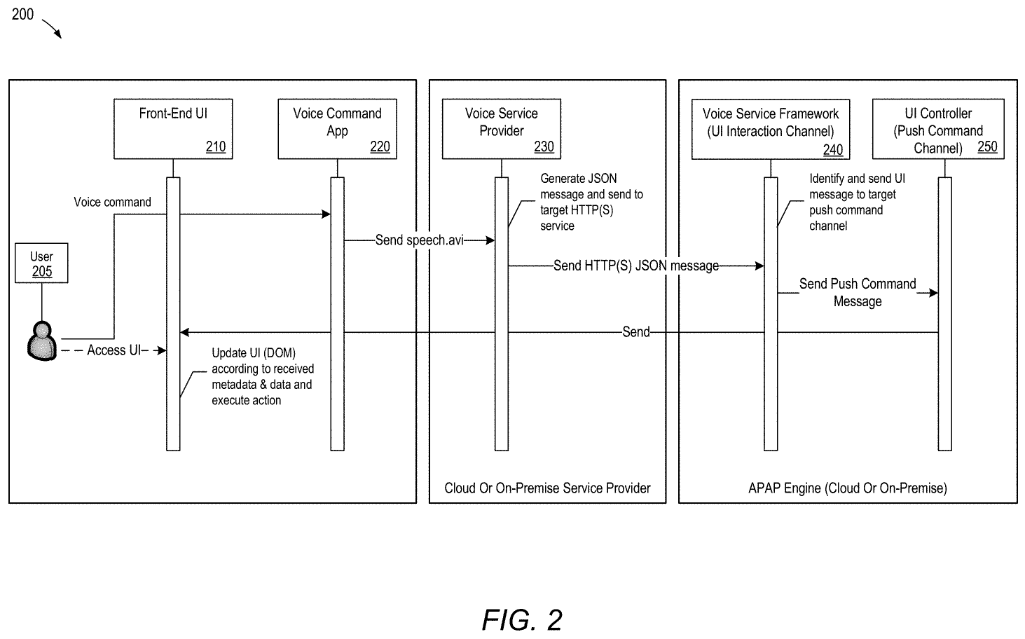

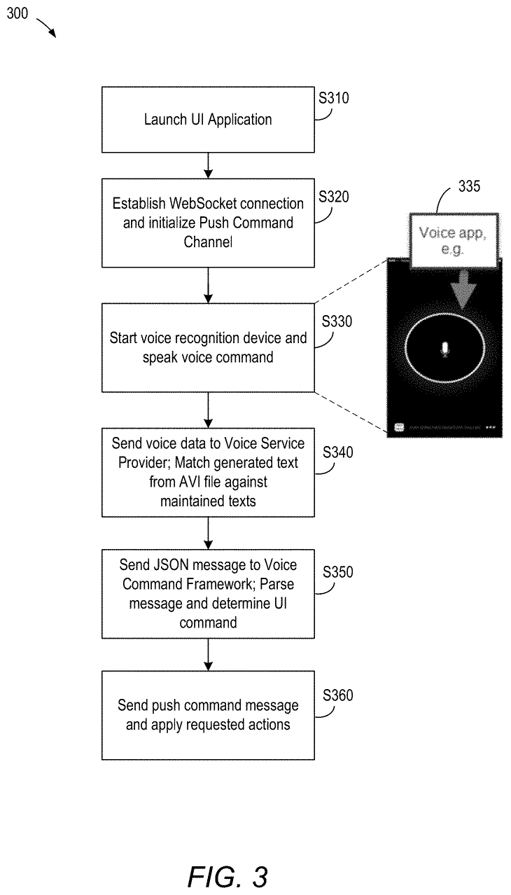

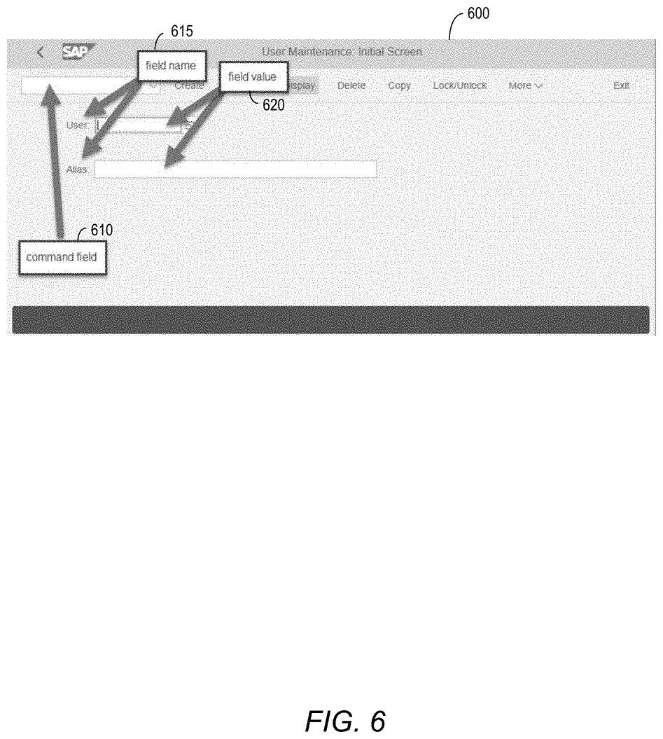

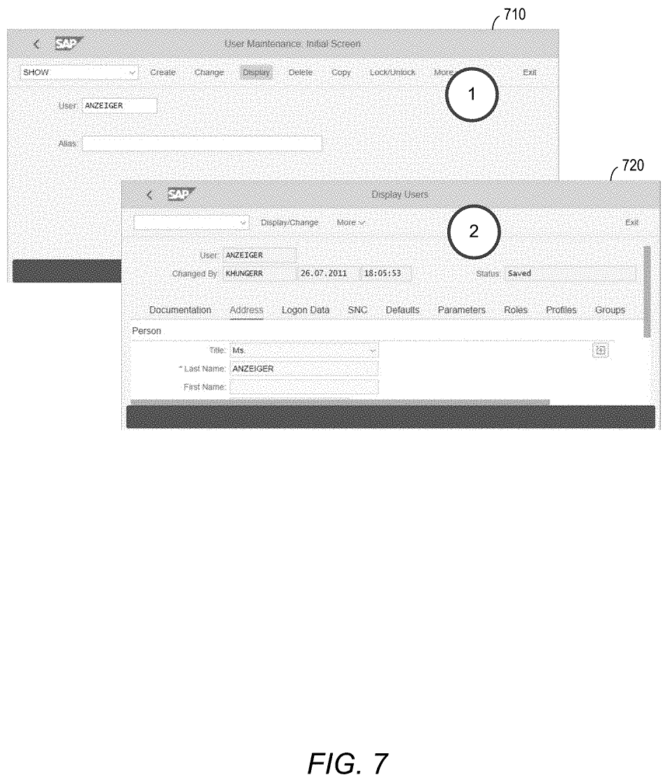

Reference is now made to FIGS. 2 and 3, which will be discussed together, along with FIGS. 6 and 7. FIG. 2 is a sequence diagram 200 of a use case according to some embodiments. More specifically, FIG. 2 illustrates an example voice-based interaction (UI session) between a user and a UI via a UI interaction channel framework according to some embodiments. FIG. 3 is a flow diagram illustrating an exemplary process 300 according to some embodiments. FIGS. 6 and 7 are outward views of user interfaces according to some embodiments.

An embodiment may be implemented in a system using advanced business application programming ((ABAP) as developed by SAP AG, Walldorf, Germany)) sessions, and/or any other types of sessions.

Initially, at S310, a user 205 launches a UI application (e.g., a business application) executing on a user interface platform on the user's computing device. FIG. 6 illustrates a specific example of a user interface 600 presented to a user for receiving user input. User interface 600 can present a user with a number of different input fields (e.g., a command field 610 and field value 620 for a given field 615). UI 600 can be presented in a spreadsheet, discrete application, mobile phone application, tablet device application, or other graphical environments.

This leads to establishment of a WebSocket connection at S320 (e.g., execution of an ABAP push center (APC) application in back-end) and initialization of a Push Command Channel (e.g., user-specific ABAP messaging (AMC) channel will be bound to the WebSocket connection). A dedicated backed APC application may be provided for the establishment of a WebSocket connection (e.g., ABAP push channel). A Push Command Channel enables communication with the UI, for example, to allow a back-end system to trigger an action in the UI (e.g., push information to the UI).

Front-end UI 210 displays a user interface for initiating a command to launch an application (e.g., business application) on a display of a computer from which a user 205 can select an operation the computer is to perform.

Next, a user 205 issues a command to a front-end UI 210 (e.g., conversational UI application for UserX) via any of several input sources (e.g., a voice recognition device, remote control device, keyboard, touch screen, etc.). In some embodiments, UI 210 dialogs with the user to complete, disambiguate, summarize, or correct queries. Generally, a user 205 may use a voice command or depress a button or other means to start the interaction process.

In one embodiment, as shown in FIG. 2, user 205 issues (e.g., utters) a voice command to a front-end UI 210. A voice command platform (e.g., intelligent assistant device) provides an interface between a user and voice command applications 220 for speech communication. For example, at S330, user 205 starts a voice recognition device (e.g., voice application 335 operating on a mobile device) and speaks a voice command. In some embodiments, an Audio Video Interleave (AVI) file is generated (e.g., “speech.avi”). The voice recognition device, including a voice inputting unit (e.g., microphone) using a voice recognition module, may be adapted to recognize a plurality of predetermined speech commands from the user.

In one aspect, voice interaction models are created. The interaction model entities, such as skills, intents, and tokens (parameters), for the target service provider are maintained. These entities may be created for business UIs by using definition and modeling tools such as the repositories of the underlying UI technology (e.g., WebGUI/SAPGUI, Web Dynpro, BSP, or UI5/Fiori).

In one embodiment, a user 205 interacts with a voice command application 220 using trigger words (also known as “hotwords” or keywords) so that a voice command application 220 knows that it is being addressed. User also identifies a skill for interacting with the virtual assistant. For example, a user 205 may issue a voice command to voice command application 220 similar to, “Alexa, ask ABAP to go to transaction [SM04]” or “Alexa, ask ABAP to execute transaction [SU01] with command [SHOW] and user [ANZEIGER].” In this case, “Alexa” is the trigger word to make the virtual assistant listen, and “ABAP” identifies the skill that the user wants to direct their enquiry to.

In some embodiments, voice interaction services are provided by third-party devices and apps (e.g., APIs) such as Alexa Skills Kit (Alexa) from Amazon, SiriKit (Siri) from Apple, Actions on Google/api.ai (Google Now) from Google, and Cortana Skills Kit from Microsoft, etc.

At S340, voice command app 220 sends the request (e.g., voice data) to a voice service provider platform 230, which handles speech recognition, handles text-to-speech, and maps voice commands to JavaScript Object Notation (JSON) intents. A user's speech is turned into tokens identifying the intent and any associated contextual parameters. In one embodiment, the generated text out of the AVI file (e.g., “speech.avi”) is matched against maintained texts (e.g., skills and utterances).

Next, at S350, the intent and parameters for the user's request are sent as a JSON message to a target HTTP(S) service. In one embodiment, voice command framework 240 receives the JSON via a HTTP(S) request. In some embodiments, the generated JSON message including user context information (e.g., identification of the user) is sent either directly or via a cloud platform (e.g., SAP Cloud Platform), to the target system (e.g., ABAP system. By way of voice command framework 240 (e.g., an abstraction layer) that is implemented for voice recognition and interaction services, access to UIs via speech commands can be enabled.

UI interaction channel framework (e.g., voice service framework 240) receives the JSON message, parses and interprets the JSON message, reading the intent and context, and in turn, at S360, identifies and sends a UI message to a target push command channel 250 (e.g., bi-directional communication channel). For example, the proper UI commands are determined and transferred to the associated UI WebSocket connection belonging to the user in the ABAP system.

End-user UI controller 250 receives the push command message and applies the requested actions (e.g., update UI Document Object Model (DOM) and/or initiate, if requested, the HTTP/REST-request to back-end system and provide a proper response to the requested action). For example, end-user UI controller 250 finds the right UI screen to push information with associated metadata to, and manipulates the UI to perform/execute the action on the UI.

In some embodiments, UI interaction channel 240 receives the response from the UI controller 250 and maps it appropriately to a voice interaction response (e.g., JSON response) and sends it back to the voice service provider 230, and then to the voice command application 220.

The generated JSON messages during voice or text interactions with a user's UI are transferred (securely) to the target business application (e.g., SAP S/4 HANA). The user's UI session is transferred via a proper REST service. Depending on the deployment mode of the business application system (e.g., cloud or on-premise), the integration of cloud service providers for voice interaction models takes place either directly or via an intermediary that acts as a software gateway for forwarding the JSON message to the target system and user session.

Advantageously, by way of UI interaction channel 240, 440 the amount of time and resources for the implementation and operation of voice- or text-based interaction services in existing and future business application UIs are reduced tremendously.

As described above, the UI interaction channel framework (voice command framework) of type HTTP or WebSocket application is created. WebSocket provides a bi-directional communication channel over a TCP/IP socket and can be used by any client or server application. This framework is responsible for receiving JSON messages (with or without an intermediary) from a voice interaction service provider. The framework then triggers the necessary UI actions for the identified user UI in the system and responds with a proper JSON message. In some embodiments, the interaction between the voice device or app and the back-end session takes place during the whole lifecycle of the conversational session. The push commands for updating a target user's UI include, for example, the received JSON message, the active user's application context, and the user's role information in the tenant.

In addition to JSON, it is contemplated that other languages or schemes (e.g., XML) can be utilized in the data messages that are exchanged, for example, between the voice service provider 230 and the voice service framework 240.

The enhancement of UI components with interaction push channel commands enables updating the UI DOM and providing proper messages for the requested actions or responses (e.g., acknowledgement, error, prompt messages, etc.).

FIG. 7 illustrates a specific example of updating the UI (DOM) (e.g., from UI screen “1”, 710 to UI screen “2”, 720). For example, at screen 710 a user may speak the command “Alexa, ask ABAP to execute transaction [SU01] with command [SHOW] and user [ANZEIGER].” When the action is triggered, respective screen 720 may be presented, which shows the information requested for user [ANZEIGER].

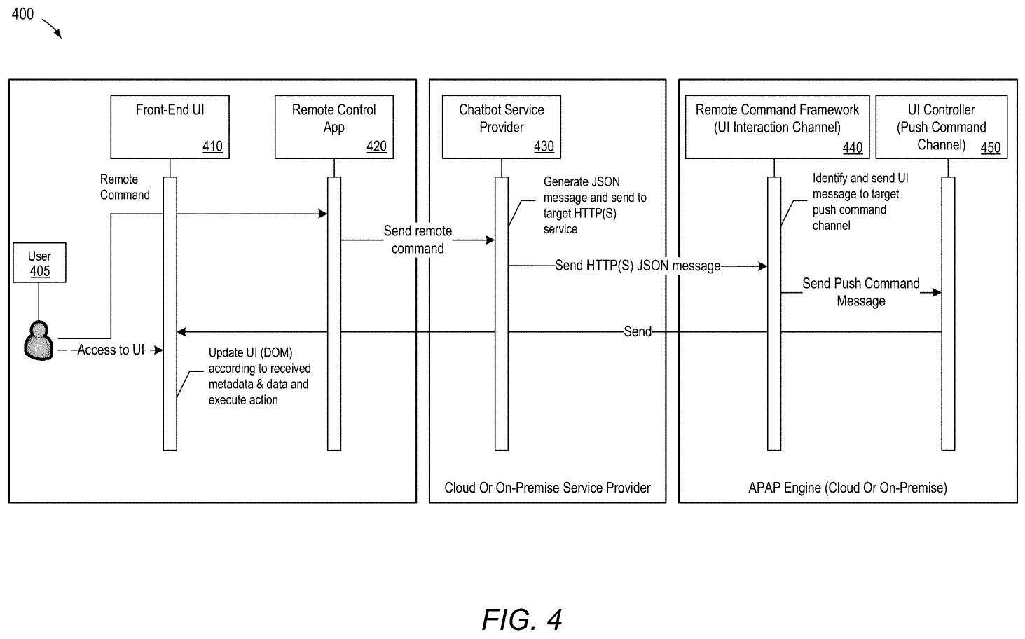

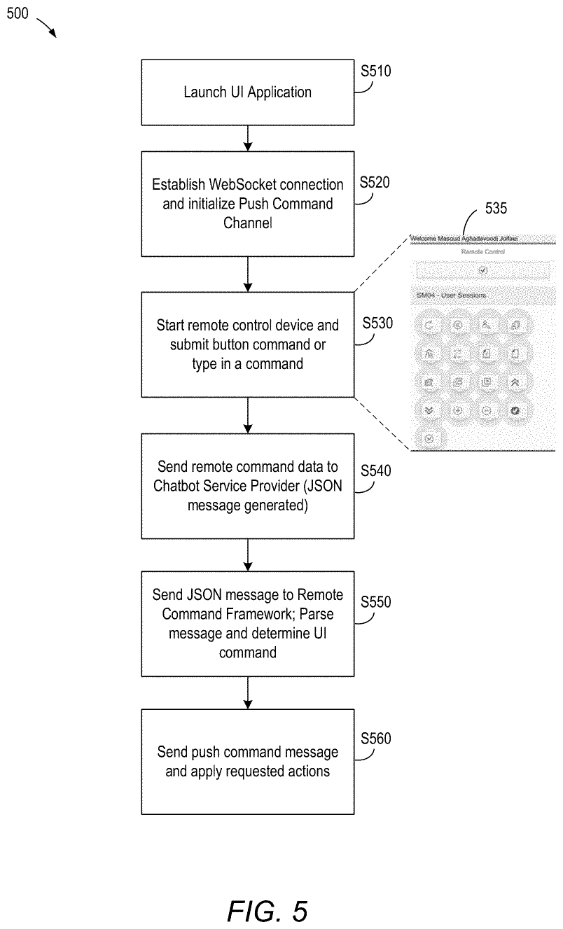

As shown in FIGS. 4 and 5, a similar interaction service can be used with text-based interactions (e.g., in messengers as embedded chatbot services).

Reference is now made to FIGS. 4 and 5, which will be discussed together. FIG. 4 is a sequence diagram 400 of a use case according to some embodiments. More specifically, FIG. 4 illustrates an example text-based interaction session (UI session) between a user and a UI via a UI interaction channel framework according to some embodiments. FIG. 5 is a flow diagram illustrating an exemplary process 500 according to some embodiments.

An embodiment may be implemented in a system using advanced business application programming ((ABAP) as developed by SAP AG, Walldorf, Germany)) sessions, and/or any other types of sessions.

Initially, at S510, a user 405 launches a UI application (e.g., a business application) executing on a user interface platform on the user's computing device.

This leads to establishment of a WebSocket connection at S520 (e.g., execution of an ABAP push center (APC) application in back-end) and initialization of a Push Command Channel (e.g., user-specific ABAP messaging (AMC) channel will be bound to the WebSocket connection). A dedicated backed APC application may be provided for the establishment of a WebSocket connection. A Push Command Channel enables communication with the UI, for example, to allow a back-end system to trigger an action in the UI (e.g., push information to the UI). The interaction model is based on a JSON structured request-response (conversational) pattern.

Front-end UI 410 displays a user interface for initiating a command to launch an application (e.g., business application) on a display of a computer from which a user 405 can select an operation the computer is to perform. In one embodiment, as shown in FIG. 4, a user 405 issues a remote command to front end-UI 410. For example, at S530, user 405 starts a remote control device (e.g., remote control 535 comprising UI buttons, clicking of which trigger various actions) and submits a button command. Alternatively, user 405 may type in a command (e.g., in a command field) and submit the command. In some embodiments, a JSON message is generated (e.g., for each of the applied actions) and sent to chatbot service provider 430.

At S540, remote control app 420 sends the request (e.g., remote command data) to a chatbot service provider platform 430, which generates a JSON message. The JSON message including the triggered action is sent to remote command framework 440. By way of remote command framework 440 that is implemented for text-based interaction services, access to UIs via text commands can be enabled.

UI interaction channel framework (e.g., remote command service framework 440) receives the JSON message, parses and interprets the JSON message, reading the intent and context, and in turn, at S560, identifies and sends a UI message to a target push command channel 450 (e.g., bi-directional communication channel). For example, the proper UI commands are determined and transferred to the associated UI WebSocket connection belonging to the user in the ABAP system.

In addition to JSON, it is contemplated that other languages or schemes (e.g., XML) can be utilized in the messages that are exchanged, for example, between the chatbot service provider 430 and the remote command framework 440.

End-user UI controller 450 receives the push command message and applies the requested actions (e.g., update UI (DOM) and/or initiate, if requested, the HTTP/REST-request to back-end system and provide a proper response to the requested action). For example, end-user UI controller 450 finds the right UI screen to push information with associated metadata to, and manipulates the UI to perform/execute the action on the UI.

In some embodiments, UI interaction channel 440 receives the response from the UI controller 450 and maps it appropriately to a text-based interaction response (e.g., remote control response) and sends it back to the chatbot service provider 430, and then to the remote control application 420.

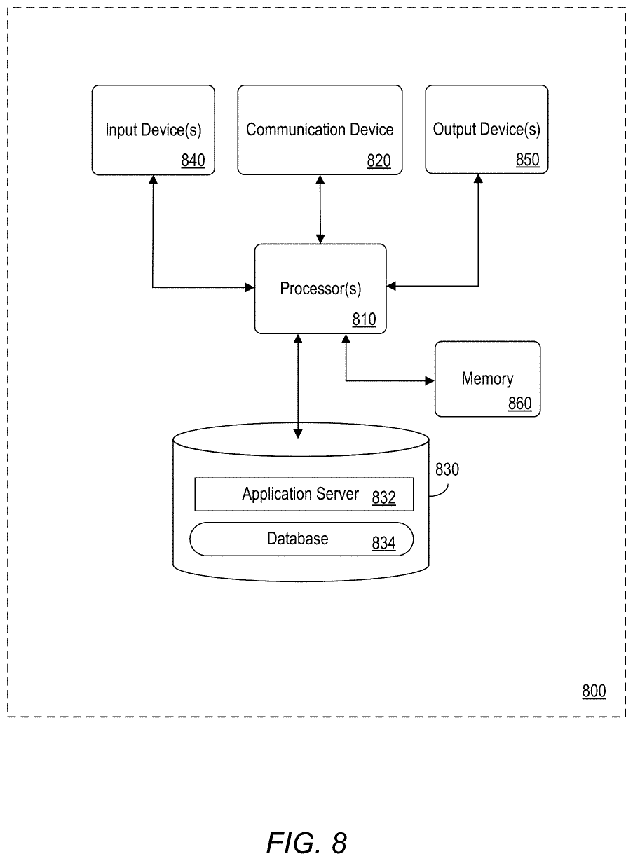

FIG. 8 is a block diagram of apparatus 800 according to some embodiments. Apparatus 800 may comprise a general- or special-purpose computing apparatus and may execute program code to perform any of the functions described herein. Apparatus 800 may comprise an implementation of one or more elements of system 100. Apparatus 800 may include other unshown elements according to some embodiments.

Apparatus 800 includes processor 810 operatively coupled to communication device 820, data storage device/memory 830, one or more input devices 840, one or more output devices 850 and memory 860. Communication device 820 may facilitate communication with external devices, such as an application server 832. Input device(s) 840 may comprise, for example, a keyboard, a keypad, a mouse or other pointing device, a microphone, knob or a switch, an infra-red (IR) port, a docking station, and/or a touch screen. Input device(s) 840 may be used, for example, to manipulate graphical user interfaces and to input information into apparatus 800. Output device(s) 850 may comprise, for example, a display (e.g., a display screen) a speaker, and/or a printer.

Data storage device 830 may comprise any appropriate persistent storage device, including combinations of magnetic storage devices (e.g., magnetic tape, hard disk drives and flash memory), optical storage devices, Read Only Memory (ROM) devices, etc., while memory 860 may comprise Random Access Memory (RAM).

Application server 832 may comprise program code executed by processor 810 to cause apparatus 800 to perform any one or more of the processes described herein. Embodiments are not limited to execution of these processes by a single apparatus. Database 834 may include database data as described above. As also described above, database data (either cached or a full database) may be stored in volatile memory such as memory 860. Data storage device 830 may also store data and other program code for providing additional functionality and/or which are necessary for operation of apparatus 800, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A computer-implemented method comprising:
establishing a back-end communication channel with a user interface;
receiving a voice command of a user to perform one or more user interface actions within the user interface;
sending voice information of the voice command to a voice service provider;
receiving, from the voice service provider, a data message generated based on the voice information;
identifying the one or more user interface actions based at least in part on the data message;
sending, using the back-end communication channel, a push command message to the user interface, the push command message including the identified one or more user interface actions; and
applying the identified one or more user interface actions within the user interface.

2. The method of claim 1, wherein the user interface is a business application interface in at least one of: an enterprise resource planning (ERP) system, a supply chain management (SCM) system, a customer relationship management (CRM) system, a supplier relationship management (SRM) system, a product lifecycle management (PLM) system, an extended warehouse management (EWM) system, and an extended transportation management (ETM) system.

3. The method of claim 1, wherein the voice command is received in a natural language format.

4. The method of claim 1, wherein applying the identified one or more user interface actions within the user interface further comprises modifying the user interface using a document object model (DOM) implementation.

5. The method of claim 1, wherein the push command message includes the data message, the user's application context, and the user's role information.

6. The method of claim 1, wherein the user interface is non-web-based.

7. A computer-implemented method comprising:
establishing a back-end communication channel with a user interface;
receiving a remote command of a user to perform one or more user interface actions within the user interface;
sending remote information of the remote command to a chatbot service provider;
receiving, from the chatbot service provider, a data message generated based on the remote information;
identifying the one or more user interface actions based at least in part on the data message;
sending, using the back-end communication channel, a push command message to the user interface, the push command message including the identified one or more user interface actions; and
applying the identified one or more user interface actions within the user interface.

8. The method of claim 7, wherein the user interface is a business application interface in at least one of an enterprise resource planning (ERP) system, a supply chain management (SCM) system, a customer relationship management (CRM) system, a supplier relationship management (SRM) system, a product lifecycle management (PLM) system, an extended warehouse management (EWM) system, and an extended transportation management (ETM) system.

9. The method of claim 7, wherein the remote command is received from a remote control device comprising one or more of a text field, a text area, a check box, radio buttons, and UI buttons.

10. The method of claim 7, wherein the remote command is received in a text format.

11. The method of claim 7, wherein applying the identified one or more user interface actions within the user interface further comprises modifying the user interface using a document object model (DOM) implementation.

12. The method of claim 7, wherein the push command message includes the data message, the user's application context, and the user's role information.

13. The method of claim 7, wherein the user interface is non-web-based.

14. A system comprising:
a processor; and
a memory in communication with the processor, the memory storing program instructions, the processor operative with the program instructions to perform the operations of:
establishing a back-end communication channel with a user interface;
receiving a voice command of a user to perform one or more user interface actions within the user interface;
sending voice information of the voice command to a voice service provider;
receiving, from the voice service provider, a data message generated based on the voice information;
identifying the one or more user interface actions based at least in part on the data message;
sending, using the back-end communication channel, a push command message to the user interface, the push command message including the identified one or more user interface actions; and
applying the identified one or more user interface actions within the user interface.

15. The system of claim 14, wherein the user interface is a business application interface in at least one of an enterprise resource planning (ERP) system, a supply chain management (SCM) system, a customer relationship management (CRM) system, a supplier relationship management (SRM) system, a product lifecycle management (PLM) system, an extended warehouse management (EWM) system, and an extended transportation management (ETM) system.

16. The system of claim 14, wherein the voice command is received in a natural language format.

17. The system of claim 14, wherein applying the identified one or more user interface actions within the user interface further comprises modifying the user interface using a document object model (DOM) implementation.

18. The system of claim 14, wherein the push command message includes the data message, the user's application context, and the user's role information.

19. The system of claim 14, wherein the user interface is non-web-based.

20. The system of claim 14, wherein the back-end communication channel comprises an Advanced Business Application Programming (ABAP) push channel connection.
